(19) United States
(12) Patent Application Publication
(10) Pub. No.: US 2020/0028153 A1
(43) Pub. Date: Jan. 23, 2020

(54) LITHIUM SECONDARY BATTERY

(71) Applicant: SK INNOVATION CO., LTD., Seoul (KR)

(72) Inventors: Kook Hyun HAN, Daejeon (KR); Kyung Bin YOO, Daejeon (KR); Duck Chul HWANG, Daejeon (KR)

(21) Appl. No.: 16/496,202

(22) PCT Filed: Mar. 21, 2018
(86) PCT No.: PCT/KR2018/003237

§ 371 Date: Sep. 20, 2019

(30) Foreign Application Priority Data
Mar. 21, 2017 (KR) 10-2017-0035139

(51) Int. Cl. H01M 4/131; H01M 10/0525; H01M 4/66

(52) U.S. Cl. CPC H01M 4/131; H01M 4/661; H01M 10/0525

(57) ABSTRACT

The present invention relates to a lithium secondary battery, more particularly relates to a lithium secondary battery having improved life-span property and penetration safety. The lithium secondary battery of the present invention includes a cathode active material including a metal that has a concentration gradient region, and an anode and a separation layer each including a ceramic coating layer so that life-span property and penetration safety can be remarkably improved.

### BACKGROUND

### 1. Field

The present invention relates to a lithium secondary battery, more particularly, relates to a lithium secondary battery having improved life-span and penetration stability.

### 2. Description of the Related Art

With rapid progress of electronic, telecommunication and computer industries, portable electronic communication devices such as a camcorder, mobile phone, notebook PC, etc. have been remarkably developed. Accordingly, demands for a lithium secondary battery as a power source capable of driving the above-mentioned device are also increasing. Particularly, with regard to applications of eco-friendly power sources for an electric car, uninterruptible power supply, electromotive tool, satellite, etc., the lithium secondary battery has been researched and developed in a domestic area and other countries such as Japan, Europe, United States, etc.

Among currently used secondary batteries, the lithium secondary battery developed at early 1990's includes an anode formed of a carbon material which is capable of absorbing and desorbing lithium ions, a cathode formed of a lithium-containing oxide, and a non-aqueous electrolyte containing lithium salt dissolved in a mixed organic solvent in a suitable amount.

As the applications of the lithium secondary battery are being expanded, the lithium secondary battery may be operated in more severe environment such as high temperature or low temperature.

However, a lithium transition metal oxide or a composite oxide used as a cathode active material of the lithium secondary battery may become thermally unstable due to desorption of a metal ingredient when being stored at high temperature in a full-charged state. Further, when a forced internal short circuit occurs due to an external impact, an exothermal from an inside of the battery may be rapidly increased to cause ignition.

To resolve the above-mentioned problems, Korean Patent Laid-Open Publication No. 2006-0134631 discloses a cathode active material having a core-shell structure in which a core portion and a shell portion are made of different lithium transition metal oxides, however, still may not provide sufficient life-span and battery safety.

### SUMMARY

It is an object of the present invention to provide a lithium secondary battery having excellent life-span property and penetration safety.

According to the present invention, a lithium secondary battery includes a cathode, an anode, and a separation layer interposed between the cathode and the anode. The cathode includes a cathode active material containing a lithium-metal oxide of which at least one of metals therein has a concentration gradient region between a central portion and a surface portion. At least one of the anode and the separation layer includes a ceramic coating layer on a surface thereof, and a sum of a thickness of the ceramic coating layer is 4 μm or more.

In the lithium secondary battery according to the present invention, the lithium-metal oxide may be represented by Chemical Formula 1 below, and at least one of M1, M2 and M3 may have a concentration gradient region between the central portion and the surface portion:

LiₓM1ₐM2_{b}M3_{c}O_{y} [Chemical Formula 1]

(wherein M1, M2 and M3 are selected from a group consisting of Ni, Co, Mn, Na, Mg, Ca, Ti, V, Cr, Cu, Zn, Ge, Sr, Ag, Ba, Zr, Nb, Mo, Al, Ga and B, and 0<x≤1.1, 2≤y≤2.02, 0≤a≤1, 0≤b≤1, 0≤c≤1, and 0<a+b+c≤1).

In the lithium secondary battery according to the present invention, the ceramic coating layer may include ceramic particles in an amount of 80 to 97 wt % based on a total weight of the ceramic coating layer.

In the lithium secondary battery according to the present invention, the ceramic coating layer may include ceramic particles being a metal oxide that includes at least one metal selected from a group consisting of aluminum (Al), titanium (Ti), zirconium (Zr), barium (Ba), magnesium (Mg), boron (B), yttrium (Y), zinc (Zn), calcium (Ca), nickel (Ni), silicon (Si), lead (Pb), strontium (Sr), tin (Sn) and cerium (Ce).

In the lithium secondary battery according to the present invention, the ceramic coating layer may include at least one ceramic particle selected from a group consisting of Al₂O₃, TiO₂, ZrO₂, Y₂O₃, ZnO, CaO, NiO, MgO, SiO₂, SiC, Al(OH)₃, AlO(OH), BaTiO₃, PbTiO₃, PZT, PLZT, PMN-PT, HfO₂, SrTiO₃, SnO₃ and CeO₂.

In the lithium secondary battery according to the present invention, the ceramic coating layer is included both the anode and the separation layer.

In the lithium secondary battery according to the present invention, a thickness of the ceramic coating layer included in one surface of the anode or the separation layer may be 1 to 10 μm.

In the lithium secondary battery according to the present invention, the sum of the thickness of the ceramic coating layer may be 4 to 30 μm.

In the lithium secondary battery according to the present invention, the sum of the thickness of the ceramic coating layer may be 4 to 12 μm, a sum of a thickness of the ceramic coating layer included on at least one surface of the separation layer may be 2 to 6 μm, and a thickness of the ceramic coating layer included on at least one surface of the anode may be 2 to 10 μm

The lithium secondary battery according to the present invention includes a combination of the cathode active material containing the metal having the continuous concentration gradient, and the anode and the separation film at least one of which may include the ceramic coating layer, so that lifespan property and penetration stability may be both remarkable improved.

### BRIEF DESCRIPTION OF THE DRAWINGS

FIG. 1 is a view schematically illustrating positions for measuring concentrations of metal elements included in a lithium-metal oxide according to exemplary embodiments.

FIG. 2 is an image showing a cross section of a lithium-metal oxide of Example 1.

FIG. 3 is an image showing a cross section of a lithium-metal oxide of Comparative Example 1.

### DETAILED DESCRIPTION OF THE EMBODIMENTS

The present invention relates to a lithium secondary battery. More particularly, the lithium secondary battery includes a cathode, an anode electrode and a separation film interposed therebetween. The cathode includes a cathode active material containing a lithium-metal oxide in which at least one of metals has a continuous concentration gradient region between a core portion and a surface portion. A ceramic coating layer is formed on a surface of at least one of the anode or the separation film, and a total thickness of the ceramic coating layer is 4 μm or more. Thus, the lithium secondary battery has improved properties on life-span and penetration stability.

Hereinafter, the present invention will be described in more detail.

The present invention relates to a lithium secondary battery including a cathode, an anode and a separation film interposed therebetween.

Cathode

The cathode according to the present invention includes a cathode active material containing a lithium-metal oxide in which at least one metal except for lithium has a concentration gradient region between a central portion and a surface portion.

The cathode active material used in the present invention includes the lithium-metal oxide having the continuous concentration region between the central portion and the surface portion so that the cathode active material may have an improved life-span property compared to that of a cathode active material without a concentration change, and may have enhanced penetration safety when used together with an anode and a separation film according to the present invention.

The concentration gradient region may be formed at a specific region between the central portion and the surface portion. In the present invention, the concentration gradient range of a metal in the lithium-metal oxide indicates that a metal except for lithium has a concentration distribution region which changes in a constant tendency between the central portion and the surface portion of the lithium-metal oxide. The constant tendency indicates that an entire concentration change trend increases or decreases, and a reverse trend in a specific point is not excluded within a scope not departing from the present invention.

The lithium-metal oxide according to an embodiment of the present invention may be represented by Chemical Formula 1 below.

LiₓM1ₐM2_{b}M3_{c}O_{y} [Chemical Formula 1]

(In the Chemical Formula 1 M1, M2 and M3 are selected from a group consisting of Ni, Co, Mn, Na, Mg, Ca, Ti, V, Cr, Cu, Zn, Ge, Sr, Ag, Ba, Zr, Nb, Mo. Al, Ga and B, 0<x≤1.1, 2≤y≤2.02, 0≤a≤1, 0≤b≤1, 0≤c≤1, 0<a+b+c≤1)

Preferably, M1 is Ni, and Ni may have a decreasing concentration gradient region between the central portion and the surface portion. M2 is Co, and Co may have a constant concentration from the central portion to surface portion. M3 is Mn, and Mn may have a decreasing concentration gradient region between the central portion and the surface portion. Preferably, 0.6≤a≤0.95 and 0.05≤b+c≤0.4.

In the present invention, the central portion of the particle means an area within 0.2 μm radius from a center of the active material particle, and the surface portion means an area within 0.2 μm from an outermost portion of the particle.

The lithium-metal oxide according to the present invention may have a relatively higher content of nickel (Ni). Using Ni may be advantageous to improving a capacity of the battery. In a structure of a conventional cathode active material, if a content of Ni is high, life-span may be deteriorated. However, in the cathode active material according to the present invention, life-span property may not be deteriorated even though Ni content is increased. Therefore, the cathode active material of the present invention may provide enhanced life-span property while maintaining a high capacity.

For example, in the lithium-metal oxide according to the present invention, a molar ratio of Ni may range from 0.6 to 0.95, preferably 0.7 to 0.9. If M1 is Ni in the above Chemical Formula 1, 0.6≤a≤0.95 and 0.05≤b+c≤0.4, and preferably, 0.7≤a≤0.9 and 0.1≤b+c≤0.3.

A particle shape of the lithium-metal oxide according to the present invention is not specifically limited, and a primary particle thereof preferably has a rod-type shape.

A particle size of the lithium-metal oxide according to the present invention is not specifically limited, for example, may be in a range from 3 to 20 μm.

The cathode active material according to the present invention may further include a coating layer on the above-described lithium-metal oxide. The coating layer may be formed of a metal or metal oxide including, for example, Al, Ti, Ba, Zr, Si, B, Mg, P, and an alloy thereof or an oxide of the metal.

As necessary, the cathode active material according to the present invention may be doped with a metal or a metal oxide. The metal or the metal oxide capable of being doped may include Al, Ti, Ba, Zr, Si, B, Mg, P, and an alloy thereof or an oxide of the metal.

The lithium-metal oxide according to the present invention may be prepared by co-precipitation.

Hereinafter, a method for preparing a cathode active material according to one embodiment of the present invention will be described.

First, metal precursor solutions having different concentrations from each other are prepared. The metal precursor solution is a solution containing a precursor of at least one metal being contained in the cathode active material. The metal precursor may generally include a halide, a hydroxide, an acid salt, etc., of the metal.

In a fabrication the metal precursor solution, a precursor solution having a concentration corresponding to a composition of the central portion of the cathode active material and a precursor solution having a concentration corresponding to a composition of the surface portion of the cathode active material are each prepared, to obtain two precursor solutions. For example, when fabricating a cathode active material of a metal oxide containing nickel, manganese and cobalt in addition to lithium, a precursor solution having a concentration of nickel, manganese and cobalt corresponding to the composition of the central portion of the cathode active material and a precursor solution having a concentration of nickel, manganese and cobalt corresponding to the composition of the surface portion of the cathode active material are each prepared.

Next, the prepared two metal precursor solutions are mixed to form a precipitate. During the mixing, a mixing ratio of the two metal precursor solutions is continuously changed so as to correspond to a desired concentration gradient in the active material. Accordingly, a metal concentration in a precipitate has a concentration corresponding to the concentration gradient in the active material. The precipitation may be performed by adding a chelating agent and a base during mixing the above solutions.

The obtained precipitate may be thermally treated, and may be mixed with a lithium salt and then thermally treated again to achieve the cathode active material according to the present invention.

A solvent and optionally a binder, a conductive agent, a dispersive agent, etc. may be added to the cathode active material, and mixed and stirred to prepare a slurry. The slurry may be applied (coated) to a current collector including a metal material, and then dried and pressed to form the cathode according to the present invention.

The binder may include any one commonly used in the related art without a particular limitation. For example, an organic binder such as polyvinylidene fluoride-hexafluoropropylene copolymer (PVDF-co-HFP), polyvinylidene fluoride (PVDF), polyacrylonitrile, polymethyl methacrylate, etc., or an aqueous binder such as styrene-butadiene rubber (SBR), etc., may be used together with a thickener such as carboxymethyl cellulose (CMC).

The conductive agent may include a widely-known conductive carbon-based agent commonly without a particular limitation.

The current collector of the metal material may include any metal having high conductivity to which the cathode active material or an anode material may be easily attached and having no reactivity within a voltage range of the battery. Non-limiting examples of a cathode current collector include a foil prepared from aluminum, nickel or a combination thereof. Non-limiting examples of an anode current collector includes a foil prepared from copper, gold, nickel, a copper alloy or a combination thereof.

Anode

An anode according to the present invention may include a ceramic coating layer on at least one surface thereof, and preferably, the ceramic coating layers may be formed on both surfaces of the anode.

In the secondary battery of the present invention, the cathode including the cathode active material of a specific concentration construction, the anode including the ceramic coating layer and a separation layer including a ceramic coating layer as described below may be interacted so that life-span property and penetration safety of the battery may be remarkably improved.

The anode of the present invention may include an anode active material coated thereon. An anode active material may be coated, dried and pressed on a copper substrate, and then a ceramic coating solution including ceramic particles may be coated on at least one surface of the anode, and then dried to form the ceramic coating layer.

The ceramic particles used in the ceramic coating layer of the anode according to the present invention may have a particle diameter of 0.01 to 2.0 μm, and preferably, 0.3 to 1.5 μm. Within the above range, proper dispersibility may be maintained.

The ceramic particles included in the ceramic coating layer of the anode may include an oxide of at least one metal of aluminum (Al), titanium (Ti), zirconium (Zr), barium (Ba), magnesium (Mg), boron (B), yttrium (Y), zinc (Zn), calcium (Ca), nickel (Ni), silicon (Si), lead (Pb), strontium (Sr), tin (Sn) and cerium (Ce). Specifically, the oxide may include Al₂O₃, TiO₂, ZrO₂, Y₂O₃, ZnO, CaO, NiO, MgO, SiO₂, SiC, Al(OH)₃, AlO(OH), BaTiO₃, PbTiO₃, PZT, PLZT, PMN-PT, HfO₂, SrTiO₃, SnO₃, CeO₂, etc., but it is not limited thereto. These may be used alone or in a combination thereof.

The ceramic particles included in the ceramic coating layer of the anode may be included in an amount of 80 to 97 weight % to a total weight of the ceramic coating layer, and preferably 85 to 95 wt %.

A ceramic coating composition for the anode electrode according to the present invention may include a binder resin, a solvent, other additives, etc., other than the ceramic particles.

The binder resin that may be used in the present invention may include polyvinylidenefluoride-co-hexafluoropropylene, polyvinylidene fluoride-trichloroethylene, polymethylmethacrylate, polyacrylonitrile, polyvinylpyrrolidone, polyvinylacetate, polyethylene-co-vinyl acetate, polyimide, polyethylene oxide, cellulose acetate, cellulose acetate butyrate, cellulose acetate propionate, cyanoethylpullulan, cyanoethylpolyvinylalcohol, cyanoethylcellulose, cyanoethylsucrose, pullulan, carboxyl methyl cellulose, polyvinylalcohol, or the like, but it is not limited thereto.

The solvent that may be used in the present invention may include tetrachloroethane, methylene chloride, chloroform, 1,1,2-trichloroethane, tetrahydrofuran, 1,4-dioxane, cyclohexanone, dimethylformamide, dimethylacetamide, dimethylsulfoxide, N-methyl-2-pyrrolidone, etc., but it is not limited thereto.

A method of forming the ceramic coating layer according to the present invention is not particularly limited, but various methods such as, for example, a dip coating, a die coating, a roll coating, a comma coating, or a combination thereof may be used.

A thickness of the ceramic coating layer formed on one surface of the anode according to the present invention is not particularly limited, but may be 1 to 10 μm, preferably 2 to 10 μm, 3 to 10 μm, or 3 to 7 μm. Within the above range, an electrode short-circuit may be prevented even when the separation film is contracted so that penetration safety of the battery may be further improved.

The ceramic coating layer of the anode according to the present invention may be formed on at least one surface of the anode. When the ceramic coating layer is formed as double-sided coating layers, a total thickness of the ceramic coating layers may be in a range from 2 to 20 μm. Within the above range, the penetration safety of the battery may be more improved, and thus the double-sided ceramic coating layers may be preferable.

The anode active material according to the present invention may include any material commonly used in the related art without particular limitation thereof.

The anode active material that may be used in the present invention may include any material known in the related art which can absorb and desorb lithium ions, without particular limitation thereof. For example, a carbon-based material such as a crystalline carbon, an amorphous carbon, a carbon composite, a carbon fiber, etc., a lithium metal, an alloy of lithium and other elements, silicon, or tin may be used. The amorphous carbon may include, for example, hard carbon, cokes, mesocarbon microbead (MCMB) calcined at a temperature of 1500° C. or less, mesophase pitch-based carbon fiber (MPCF), or the like. The crystalline carbon may include a graphite-based material, specifically a natural graphite, a graphite cokes, a graphite MCMB, a graphite MPCF, or the like. Other elements forming the alloy with lithium may include aluminum, zinc, bismuth, cadmium, antimony, silicone, lead, tin, gallium or indium.

A size of the graphite used in the present invention is not particularly limited, but the graphite may have an average particle diameter of 5 to 30 μm.

A solvent and optionally a binder, a conductive agent, a dispersive agent, etc. may be added to the above-mentioned anode active material, and mixed and stirred to prepare a mixture. The mixture may be applied (coated) to a current collector including a metal material, and then dried and pressed to form the anode according to the present invention. The solvent, the binder, the conductive agent, the dispersive agent and the preparing method the same as those for forming the cathode as described above may be used.

Separation Layer

The separation layer according to the present invention is interposed between the cathode and the anode to insulate the cathode and the anode from each other, and may include a ceramic coating layer on at least one surface thereof.

In the secondary battery of the present invention, an interaction between the cathode including the cathode active material of the above-mentioned specific concentration construction, and at least one of the anode including the ceramic coating layer and the separation layer including the ceramic coating layer may be implemented so that life-span property and penetration safety of the battery may be remarkably improved. Preferably, the ceramic coating layers may be formed on both the anode and the separation layer.

The separation layer according to the present invention may include a substrate film, and the ceramic coating layer formed by applying a ceramic coating composition containing ceramic particles to at least one surface of the substrate film.

The substrate film that may be used in the present invention may include a commonly-used porous polymer film, for example, formed of a polyolefin polymer such as ethylene homopolymer, propylene homopolymer, ethylene/butene copolymer, ethylene/hexene copolymer and ethylene/methacrylate copolymer, which may be used alone or as a laminate. A conventional porous woven fabric, for example, a woven fabric formed of a high-melting point glass fiber, a polyethylene terephthalate fiber, etc., may be also used, but it is not particularly limited thereto.

The materials used in the ceramic coating layer of the separation layer according to the present invention may be the same as those for the anode as described above, and the fabrication method in the anode may be also applied in the separation layer.

The ceramic particles that may be used in the ceramic coating layer of the separation layer according to the present invention may have a particle diameter of 0.01 to 2.0 μm, preferably 0.3 to 1.5 μm. Within the above range, proper dispersibility may be maintained.

The ceramic particles included in the ceramic coating layer of the separation layer may be included in an amount of 80 to 97 wt % to a total weight of the ceramic coating layer, and preferably 85 to 95 wt %.

A thickness of the ceramic coating layer coated on any one surface of the substrate film according to the present invention is not particularly limited but may be 1 to 10 μm, preferably 1 to 7 μm, more preferably 1 to 3 μm. When the ceramic coating layers are formed on both surfaces of the separation layer, a sum of the thicknesses may be in a range from 2 to 14 μm, preferably from 2 to 6 μm.

Within the above range, the separation layer may be prevented from being contracted when a penetration occurs so that the penetration safety of the battery may be more improved, and a drastic decrease of the life-span may be effectively suppressed.

Lithium Secondary Battery

As described above, the secondary battery of the present invention may include the ceramic coating layers formed on the anode or the separation layer, and a sum of thicknesses of the ceramic coating layers formed on the surface of at least one of the anode and the separation film may be 4 μm or more. Accordingly, in the secondary battery of the present invention, the cathode including the cathode active material of the above-mentioned specific concentration construction, and the anode and the separation layer including the ceramic coating layers of the specific thickness range may be interacted so that life-span property and penetration stability of the battery may be remarkably improved. If the sum of the thickness of the ceramic coating layer formed on the surface of at least one of the anode and the separation layer is less than 4 μm, the penetration safety may be drastically deteriorated.

An upper limit of the sum of the thickness of the entire ceramic coating layers included in the separation layer and the anode is not be specifically limited. For example, the sum of the thickness may be in a range from 4 to 30 μm, preferably 4 to 12 μm or 5 to 12 μm.

In a preferable embodiment of the present invention, a total thickness of the ceramic coating layers included in the separation layer and the anode may be in a range from 4 to 12 μm, a sum of the thickness formed on the surface of the separation layer may be in a range from 2 to 6 μm, and a sum of the thickness formed on the surface of the anode may be in a range from 2 to 10 μm. Within this range, the life-span property and the penetration safety of the battery may be further improved. In another preferable embodiment from this aspect, a total thickness of the entire ceramic coating layers may be in a range from 5 to 12 μm, a sum of the thickness formed on the surface of the separation layer may be in a range from 2 to 6 μm, and a sum of the thickness formed on the surface of the anode may be in a range from 3 to 10 μm.

When the ceramic coating layers are formed on both the anode and the separation layer, the lithium secondary battery according to an embodiment of the present invention may have a sequential stacked structure of [ceramic coating layer/anode/ceramic coating layer], [ceramic coating layer/separation layer/ceramic coating layer] and [cathode] are sequentially laminated.

The lithium secondary battery may further include a non-aqueous electrolyte, and the non-aqueous electrolyte may include a lithium salt and an organic solvent. The lithium salt may include any one typically used as an electrolyte of the lithium secondary battery without particular limitation thereof. Representative examples of the organic solvent may include any one selected from a group consisting of propylene carbonate (PC), ethylene carbonate (EC), diethyl carbonate (DEC), dimethyl carbonate (DMC), ethylmethyl carbonate (EMC), methylpropyl carbonate, dipropyl carbonate, dimethyl sulfoxide, acetonitrile, dimethoxyethane, diethoxyethane, vinylene carbonate, sulforane, γ-butyrolactone, propylene sulfite and tetrahydrofurane, or a combination the thereof.

The non-aqueous electrolyte may be introduced into an electrode structure including the cathode, the anode and the separation layer interposed therebetween to obtain the lithium secondary battery.

A shape of the lithium secondary battery of the present invention is not specifically, but the secondary battery may be prepared as a cylindrical or square shape using a can, a pouch shape or a coin shape.

Hereinafter, preferred embodiments are proposed to more concretely describe the present invention. However, the following examples are only given for illustrating the present invention and those skilled in the related art will obviously understand that various alterations and modifications are possible within the scope and spirit of the present invention. Such alterations and modifications are duly included in the appended claims.

### Example 1

A lithium-metal oxide (hereinafter, CSG) having a whole composition of LiNi_{0.80}Co_{0.10}Mn_{0.10}O₂, a central portion composition of LiNi_{0.83}Co_{0.10}Mn_{0.07}O₂ and a surface portion composition of LiNi_{0.78}Co_{0.10}Mn_{0.12}O₂, and having a concentration gradient region between the central portion and the surface portion was used as a cathode active material, Denka Black was used as a conductive agent, and PVDF was used as a binder. The cathode active material, the conductive agent and the binder were mixed by a weight ratio of 92:5:3, respectively, to prepare a cathode slurry. T cathode slurry was coated on an aluminum substrate, and then dried and pressed to prepare a cathode.

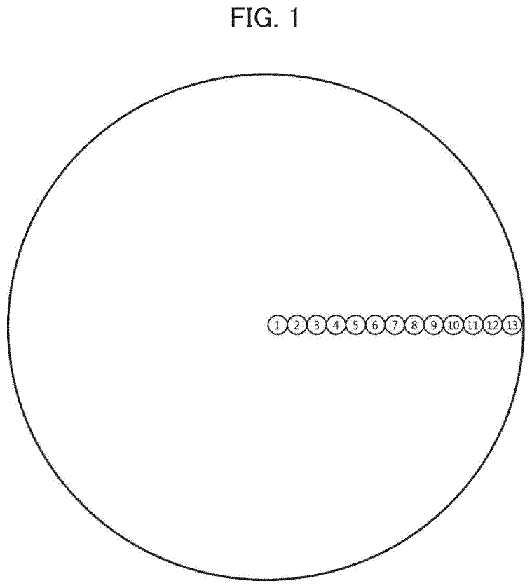

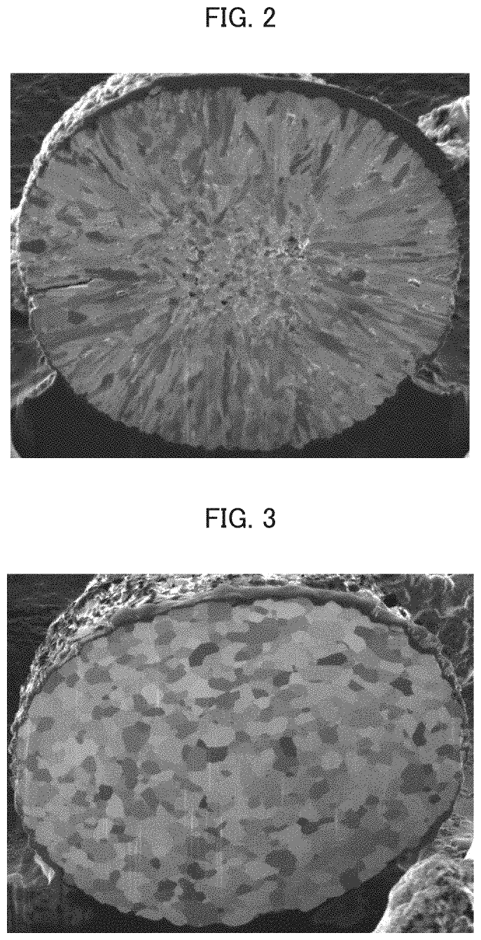

For reference, the concentration gradient of the lithium-metal oxide is shown in Table 1 below, and measurement positions of concentrations are illustrated in FIG. 1. The concentrations were measured by an interval of 0.4 μm from the surface of the lithium-metal oxide particle having a distance from a center to the surface of 4.8 μm.

TABLE 1

| Positions | Ni | Co | Mn |
|---|---|---|---|
| 1 | 83.0 | 10.0 | 7.0 |
| 2 | 83.1 | 10.1 | 6.8 |
| 3 | 82.9 | 10.0 | 7.1 |
| 4 | 83.0 | 10.0 | 7.0 |
| 5 | 80.0 | 9.9 | 10.1 |
| 6 | 78.0 | 10.0 | 12.0 |
| 7 | 78.0 | 10.0 | 12.0 |
| 8 | 78.0 | 10.1 | 11.9 |
| 9 | 78.1 | 10.0 | 11.9 |
| 10 | 77.9 | 10.1 | 12.0 |
| 11 | 78.0 | 10.0 | 12.0 |
| 12 | 78.1 | 9.9 | 12.0 |
| 13 | 78.0 | 10.0 | 12.0 |

Anode

An anode slurry including 92 wt % of natural graphite as an anode active material, 5 wt % of a flake type conductive material KS6 as a conductive agent, 1 wt % of SBR as a binder and 1 wt % of CMC as a thickener was applied to a copper substrate, followed by drying and pressing to prepare an anode active material layer. Ceramic coating layers including boehmite (AlO(OH)) and an acrylate binder by a weight ratio of 90:10 were formed on upper and lower portions of the prepared anode active material to have a thickness shown in Table 2 below.

Separation Layer

Ceramic coating layers including boehmite (AlO(OH)) and an acrylate binder by a weight ratio of 90:10 were formed on both surfaces of a polyethylene fabric having a thickness of 16 μm to have a thickness shown in Table 2 below.

Battery

The cathode and the anode obtained as described above were notched with a proper size and stacked, and the separation layer as prepared above was interposed between the cathode and the anode to form a cell. Each tab portion of the cathode and the anode was welded. The welded cathode/separation layer/anode assembly was inserted in a pouch, and three sides of the pouch except for an electrolyte injection side were sealed. The tab portions were also included in sealed portions. An electrolyte was injected through one remaining side, and then sealed followed by impregnating for more than 12 hours. The electrolyte was prepared by dissolving IM LiPF6 in a mixed solvent of EC/EMC/DEC (25/45/30; volume ratio), and then adding 1 wt % of vinylene carbonate, 0.5 wt % of 1,3-propensultone (PRS), and 0.5 wt % of lithium bis (oxalato) borate (LiBOB).

The lithium secondary battery was pre-charged by applying a current (2.5 A) corresponding to 0.25 C for 36 minutes. After 1 hour, the battery was degased, aged for more than 24 hours, and then a formation charging-discharging (charging condition of CC-CV 0.2 C 4.2 V 0.05 C CUT-OFF, discharging condition CC 0.2 C 2.5 V CUT-OFF) was performed. Then, a standard charging-discharging (charging condition of CC-CV 0.5 C 4.2 V 0.05 C CUT-OFF, discharging condition CC 0.5 C 2.5 V CUT-OFF) was performed.

### Examples 2 to 29

Batteries were fabricated by a method the same as that in Example 1 except that components and thicknesses were changed as shown in Table 2 below (The anode was also double-sided).

TABLE 2

| | | Double-sided | | | |
|---|---|---|---|---|---|
| | | Coating: | | | |
| | | ceramic coating | | | |
| | | layer thickness/ | | | |
| | | fabric thickness/ | Double-sided | Single ceramic | |
| | | ceramic | Ceramic coating | coating layer | Sum of ceramic |
| | Cathode Active | coating layer | layer thickness | thickness of | coating layer |
| | Material | thickness (μm) | of Separator | Anode | thicknesses |
| Example 1 | CSG | 1/16/1 | 2 | 3 | 5 |
| Example 2 | CSG | 1/16/1 | 2 | 5 | 7 |
| Example 3 | CSG | 1/16/1 | 2 | 7 | 9 |
| Example 4 | CSG | 1/16/1 | 2 | 10 | 12 |
| Example 5 | CSG | 2/16/2 | 4 | 0 | 4 |
| Example 6 | CSG | 2/16/2 | 4 | 3 | 7 |
| Example 7 | CSG | 2/16/2 | 4 | 5 | 9 |
| Example 8 | CSG | 2/16/2 | 4 | 7 | 11 |
| Example 9 | CSG | 2/16/2 | 4 | 10 | 14 |
| Example 10 | CSG | 3/16/3 | 6 | 0 | 6 |
| Example 11 | CSG | 3/16/3 | 6 | 3 | 9 |
| Example 12 | CSG | 3/16/3 | 6 | 5 | 11 |
| Example 13 | CSG | 3/16/3 | 6 | 7 | 13 |
| Example 14 | CSG | 3/16/3 | 6 | 10 | 16 |
| Example 15 | CSG | 5/16/5 | 10 | 0 | 10 |
| Example 16 | CSG | 5/16/5 | 10 | 3 | 13 |
| Example 17 | CSG | 5/16/5 | 10 | 5 | 15 |
| Example 18 | CSG | 5/16/5 | 10 | 7 | 17 |
| Example 19 | CSG | 5/16/5 | 10 | 10 | 20 |
| Example 20 | CSG | 7/16/7 | 14 | 0 | 14 |
| Example 21 | CSG | 7/16/7 | 14 | 3 | 17 |
| Example 22 | CSG | 7/16/7 | 14 | 5 | 19 |
| Example 23 | CSG | 7/16/7 | 14 | 7 | 21 |
| Example 24 | CSG | 7/16/7 | 14 | 10 | 24 |
| Example 25 | CSG | 10/16/10 | 20 | 0 | 20 |
| Example 26 | CSG | 10/16/10 | 20 | 3 | 23 |
| Example 27 | CSG | 10/16/10 | 20 | 5 | 25 |
| Example 28 | CSG | 10/16/10 | 20 | 7 | 27 |
| Example 29 | CSG | 10/16/10 | 20 | 10 | 30 |

### Comparative Examples 1 to 30

Batteries were fabricated by a method the same as that in Example 1 except that components and thicknesses were adjusted as shown in Table 3 below. LiNi_{0.8}Co_{0.1}Mn_{0.1}O₁₂ (hereinafter, NCM811) having a uniform composition through an entire particle was used as the cathode active material, and the anode was double-sided.

### Comparative Example 31

A battery was fabricated by a method the same as that in Example 1 except that components and thicknesses were changed as shown in Table 3 below (The anode was also double-sided).

TABLE 3

| | | Double-sided | | | |
|---|---|---|---|---|---|
| | | Coating: | | | |
| | | ceramic coating | | | |
| | | layer thickness/ | | | |
| | | fabric thickness/ | Double-sided | Single ceramic | |
| | | ceramic | Ceramic coating | coating layer | Sum of ceramic |
| | Cathode Active | coating layer | layer thickness | thickness of | coating layer |
| | Material | thickness (μm) | of Separator | Anode | thicknesses |
| Comparative | NCM811 | 1/16/1 | 2 | 0 | 2 |
| Example 1 | | | | | |
| Comparative | NCM811 | 1/16/1 | 2 | 3 | 5 |
| Example 2 | | | | | |
| Comparative | NCM811 | 1/16/1 | 2 | 5 | 7 |
| Example 3 | | | | | |
| Comparative | NCM811 | 1/16/1 | 2 | 7 | 9 |
| Example 4 | | | | | |
| Comparative | NCM811 | 1/16/1 | 2 | 10 | 12 |
| Example 5 | | | | | |
| Comparative | NCM811 | 2/16/2 | 4 | 0 | 4 |
| Example 6 | | | | | |
| Comparative | NCM811 | 2/16/2 | 4 | 3 | 7 |
| Example 7 | | | | | |
| Comparative | NCM811 | 2/16/2 | 4 | 5 | 9 |
| Example 8 | | | | | |
| Comparative | NCM811 | 2/16/2 | 4 | 7 | 11 |
| Example 9 | | | | | |
| Comparative | NCM811 | 2/16/2 | 4 | 10 | 14 |
| Example 10 | | | | | |
| Comparative | NCM811 | 3/16/3 | 6 | 0 | 6 |
| Example 11 | | | | | |
| Comparative | NCM811 | 3/16/3 | 6 | 3 | 9 |
| Example 12 | | | | | |
| Comparative | NCM811 | 3/16/3 | 6 | 5 | 11 |
| Example 13 | | | | | |
| Comparative | NCM811 | 3/16/3 | 6 | 7 | 13 |
| Example 14 | | | | | |
| Comparative | NCM811 | 3/16/3 | 6 | 10 | 16 |
| Example 15 | | | | | |
| Comparative | NCM811 | 5/16/5 | 10 | 0 | 10 |
| Example 16 | | | | | |
| Comparative | NCM811 | 5/16/5 | 10 | 3 | 13 |
| Example 17 | | | | | |
| Comparative | NCM811 | 5/16/5 | 10 | 5 | 15 |
| Example 18 | | | | | |
| Comparative | NCM811 | 5/16/5 | 10 | 7 | 17 |
| Example 19 | | | | | |
| Comparative | NCM811 | 5/16/5 | 10 | 10 | 20 |
| Example 20 | | | | | |
| Comparative | NCMS11 | 7/16/7 | 14 | 0 | 14 |
| Example 21 | | | | | |
| Comparative | NCM811 | 7/16/7 | 14 | 3 | 17 |
| Example 22 | | | | | |
| Comparative | NCM811 | 7/16/7 | 14 | 5 | 19 |
| Example 23 | | | | | |
| Comparative | NCM811 | 7/16/7 | 14 | 7 | 21 |
| Example 24 | | | | | |
| Comparative | NCM811 | 7/16/7 | 14 | 10 | 24 |
| Example 25 | | | | | |
| Comparative | NCM811 | 10/16/10 | 20 | 0 | 20 |
| Example 26 | | | | | |
| Comparative | NCM811 | 10/16/10 | 20 | 3 | 23 |
| Example 27 | | | | | |
| Comparative | NCM811 | 10/16/10 | 20 | 5 | 25 |
| Example 28 | | | | | |
| Comparative | NCM811 | 10/16/10 | 20 | 7 | 27 |
| Example 29 | | | | | |
| Comparative | NCM811 | 10/16/10 | 20 | 10 | 30 |
| Example 30 | | | | | |
| Comparative | CSG | 1/16/1 | 2 | 0 | 2 |
| Example 31 | | | | | |

### Experimental Example

1. Life-Span Property at Room Temperature

The battery cells prepared in Examples and Comparative Examples were repeatedly charged (CC-CV 2.0 C 4.2 V 0.05 C CUT-OFF) and discharged (CC 2.0 C 2.75 V CUT-OFF) 500 times, and then a discharging capacity at a 500th cycle was calculated as a percentage (%) with respect to a first cycle discharging capacity to measure the life-span property at room temperature.

The results are shown in Tables 4 and 5 below.

2. Evaluation on Penetration Safety

The batteries prepared in Examples and Comparative Examples were penetrated from an outside using a nail to check whether ignition or explosion occurred.

The results are shown in Tables 4 and 5 below.

TABLE 4

| | Life-span | |
|---|---|---|
| | (500CY) | Penetration result |
| Example 1 | 82 | Non-ignited |
| Example 2 | 85 | Non-ignited |
| Example 3 | 84 | Non-ignited |
| Example 4 | 84 | Non-ignited |
| Example 5 | 81 | Non-ignited |
| Example 6 | 84 | Non-ignited |
| Example 7 | 84 | Non-ignited |
| Example 8 | 85 | Non-ignited |
| Example 9 | 83 | Non-ignited |
| Example 10 | 82 | Non-ignited |
| Example 11 | 84 | Non-ignited |
| Example 12 | 85 | Non-ignited |
| Example 13 | 83 | Non-ignited |
| Example 14 | 83 | Non-ignited |
| Example 15 | 79 | Non-ignited |
| Example 16 | 81 | Non-ignited |
| Example 17 | 83 | Non-ignited |
| Example 18 | 83 | Non-ignited |
| Example 19 | 82 | Non-ignited |
| Example 20 | 78 | Non-ignited |
| Example 21 | 81 | Non-ignited |
| Example 22 | 83 | Non-ignited |
| Example 23 | 82 | Non-ignited |
| Example 24 | 81 | Non-ignited |
| Example 25 | 71 | Non-ignited |
| Example 26 | 73 | Non-ignited |
| Example 27 | 75 | Non-ignited |
| Example 28 | 73 | Non-ignited |
| Example 29 | 72 | Non-ignited |

TABLE 5

| | Life-span | |
|---|---|---|
| | (500CY) | Penetration result |
| Comparative | 70 | Ignited |
| Example 1 | | |
| Comparative | 71 | Ignited |
| Example 2 | | |
| Comparative | 72 | Ignited |
| Example 3 | | |
| Comparative | 71 | Ignited |
| Example 4 | | |
| Comparative | 71 | Non-ignited |
| Example 5 | | |
| Comparative | 68 | Ignited |
| Example 6 | | |
| Comparative | 69 | Ignited |
| Example 7 | | |
| Comparative | 70 | Ignited |
| Example 8 | | |
| Comparative | 70 | Non-ignited |
| Example 9 | | |
| Comparative | 69 | Non-ignited |
| Example 10 | | |
| Comparative | 65 | Ignited |
| Example 11 | | |
| Comparative | 66 | Ignited |
| Example 12 | | |
| Comparative | 67 | Non-ignited |
| Example 13 | | |
| Comparative | 66 | Non-ignited |
| Example 14 | | |
| Comparative | 66 | Non-ignited |
| Example 15 | | |
| Comparative | 60 | Non-ignited |
| Example 16 | | |
| Comparative | 61 | Non-ignited |
| Example 17 | | |
| Comparative | 62 | Non-ignited |
| Example 18 | | |
| Comparative | 62 | Non-ignited |
| Example 19 | | |
| Comparative | 61 | Non-ignited |
| Example 20 | | |
| Comparative | 55 | Non-ignited |
| Example 21 | | |
| Comparative | 56 | Non-ignited |
| Example 22 | | |
| Comparative | 57 | Non-ignited |
| Example 23 | | |
| Comparative | 56 | Non-ignited |
| Example 24 | | |
| Comparative | 56 | Non-ignited |
| Example 25 | | |
| Comparative | 50 | Non-ignited |
| Example 26 | | |
| Comparative | 51 | Non-ignited |
| Example 27 | | |
| Comparative | 52 | Non-ignited |
| Example 28 | | |
| Comparative | 51 | Non-ignited |
| Example 29 | | |
| Comparative | 51 | Non-ignited |
| Example 30 | | |
| Comparative | 81 | Ignited |
| Example 31 | | |

Referring to Tables 4 and 5, the life-span property and the penetration safety of the batteries in Examples were greater than those in Comparative Examples.

Specifically, when comparing Examples and Comparative Examples including the ceramic coating layer of the same thickness, the batteries having the cathode active material according to the present invention were non-ignited from 4 μm or more of a total ceramic coating layer thickness during the evaluation of the penetration safety. However, the batteries having the cathode active material different from that of the present invention were non-ignited from 10 μm or more of a total ceramic coating layer thickness during the evaluation of the penetration safety.

Further, in the batteries having the cathode active material of the uniform composition, the life-span property was remarkably degraded as the thickness of the ceramic coating layer became increased. However, in the batteries having the cathode active material according to the present invention, the life-span property was not greatly affected and improved life-span property was maintained even though the thickness of the ceramic coating layer was increased.

What is claimed is:

1. A lithium secondary battery, comprising a cathode, an anode, and a separation layer interposed between the cathode and the anode,
wherein the cathode includes a cathode active material containing a lithium-metal oxide of which at least one of metals therein has a concentration gradient region between a central portion and a surface portion,
wherein at least one of the anode and the separation layer includes a ceramic coating layer on a surface thereof, and a sum of a thickness of the ceramic coating layer is 4 μm or more.

2. The lithium secondary battery according to claim 1, wherein the lithium-metal oxide is represented by Chemical Formula 1 below, and at least one of M1, M2 and M3 has a concentration gradient region between the central portion and the surface portion:
LiₓM1ₐM2_{b}M3_{c}O_{y} [Chemical Formula 1]
(wherein M1, M2 and M3 are selected from a group consisting of Ni, Co, Mn, Na, Mg, Ca, Ti, V, Cr, Cu, Zn, Ge, Sr, Ag, Ba, Zr, Nb, Mo, Al, Ga and B, and
0<x≤1.1, 2≤y≤2.02, 0≤a≤1, 0≤b≤1, 0≤c≤1, and 0<a+b+c≤1).

3. The lithium secondary battery according to claim 1, wherein the ceramic coating layer includes ceramic particles in an amount of 80 to 97 wt % based on a total weight of the ceramic coating layer.

4. The lithium secondary battery according to claim 1, wherein the ceramic coating layer includes ceramic particles being a metal oxide that includes at least one metal selected from a group consisting of aluminum (Al), titanium (Ti), zirconium (Zr), barium (Ba), magnesium (Mg), boron (B), yttrium (Y), zinc (Zn), calcium (Ca), nickel (Ni), silicon (Si), lead (Pb), strontium (Sr), tin (Sn) and cerium (Ce).

5. The lithium secondary battery according to claim 1, wherein the ceramic coating layer includes at least one ceramic particle selected from a group consisting of Al₂O₃, TiO₂, ZrO₂, Y₂O₃, ZnO, CaO, NiO, MgO, SiO₂, SiC, Al(OH)₃, AlO(OH), BaTiO₃, PbTiO₃, PZT, PLZT, PMN-PT, HfO₂, SrTiO₃, SnO₃ and CeO₂.

6. The lithium secondary battery according to claim 1, wherein the ceramic coating layer is included both the anode and the separation layer.

7. The lithium secondary battery according to claim 1, wherein a thickness of the ceramic coating layer included in one surface of the anode or the separation layer is 1 to 10 μm.

8. The lithium secondary battery according to claim 1, wherein the sum of the thickness of the ceramic coating layer is 4 to 30 μm.

9. The lithium secondary battery according to claim 1, wherein the sum of the thickness of the ceramic coating layer is 4 to 12 μm, a sum of a thickness of the ceramic coating layer included on at least one surface of the separation layer is 2 to 6 μm, and a thickness of the ceramic coating layer included on at least one surface of the anode is 2 to 10 μm.
